(19) United States
(12) Patent Application Publication
(10) Pub. No.: US 2019/0351832 A1
(43) Pub. Date: Nov. 21, 2019

(54) ADJUSTABLE STAIR ASSEMBLY

(71) Applicant: Lippert Components, Inc., Elkhart, IN (US)

(72) Inventors: Nathaniel Fuller, Granger, IN (US); Barry Ousley, Syracuse, IN (US); Scott C. McKinnon, Union City, MI (US)

(21) Appl. No.: 16/413,938

(22) Filed: May 16, 2019

Related U.S. Application Data
(60) Provisional application No. 62/672,886, filed on May 17, 2018.

(51) Int. Cl. B60R 3/00; E06C 5/42; E06C 5/44; E06C 7/18; E06C 5/24; E06C 7/08

(52) U.S. Cl. CPC B60R 3/007; E06C 5/42; E06C 7/082; E06C 7/183; E06C 5/24; E06C 5/44

(57) ABSTRACT

A stair assembly may include a plurality of steps, a main stringer pivotably connected to a corresponding lateral end of each of the plurality of steps, and a support stringer pivotably connected to a corresponding lateral end of each of the plurality of steps, wherein the main stringer and the support stringer are movably connected to the plurality of steps such that the rise and the run of the plurality of steps remains consistent when the main stringer and the support stringer are moved relative to each other.

### CROSS-REFERENCES TO RELATED APPLICATIONS

This application claims priority to U.S. Provisional Application No. 62/672,886, filed May 17, 2018, the entire contents of which are incorporated herein by reference.

### BACKGROUND OF THE TECHNOLOGY

Vehicles, such as recreational vehicles (RVs) and trailers, being movable by nature may be taken to a number of different locations by the user. Such vehicles also may have one or more elevated surfaces, e.g., the interior of the RV, a fold-down patio, or a trailer bed, and it may be desirable for the user to be able to walk up and down between the ground and the elevated surface when the vehicle has reached its intended location. Due to various size and safety regulations, as well as the height of the elevated surface relative to the ground, it may not be possible or practical to integrate stairs onto the exterior of the vehicle. Thus, removable stairs may be attached to the elevated surface to allow the user to walk up and down between the ground and the elevated surface. Existing stair assemblies, however, are deficient in that they may lack sufficient adjustability to accommodate different ground heights/conditions, they may be constructed such that they are heavy and, therefore, difficult to install and remove, and the steps may lack adjustability such that the user is forced to walk up and down steps that may be at an unnatural angle and/or have an inconsistent rise and run. These deficiencies in known stair assemblies make them difficult to use and undesirable.

### BRIEF SUMMARY OF THE TECHNOLOGY

An aspect of the present technology is directed to a stair assembly that may be adjusted for an elevated surface at a variable height from the ground.

Another aspect of the present technology is directed to a stair assembly that may be adjusted to provide a consistent rise and run between steps.

Another aspect of the present technology is directed to a stair assembly that may be adjusted to provide a consistent rise and run between steps when the stair assembly is height-adjusted for a surface elevated above the ground.

Another aspect of the present technology is directed to a removable and collapsible entry stair for a recreational vehicle that may be securely connected to the vehicle. The stair includes a plurality of steps connected to stringers that may be manipulated to adjust the angle of the steps with respect to the stringers to provide level and even footing between the ground and the elevated entryway of the vehicle or deck over a range of angles of inclination of the stair with respect to the vehicle.

Another aspect of the present technology is directed to a stair assembly comprising: at least one step; a main stringer pivotably connected to the at least one step; a support stringer pivotably connected to the at least one step; and a camslot plate pivotably connected to one of the main stringer and the support stringer and pivotably and slidably connected to the other of the main stringer and the support stringer.

In examples of any of the aspects of the preceding paragraphs of this section, (a) a latching mechanism may be joined to a top end of the main stringer, the latching mechanism being configured to releasably connect the stair assembly to an anchor or a wall mount, (b) the latching mechanism may comprise a rotary latch such that the stair assembly is rotatable relative to the anchor or the wall mount when connected thereto, (c) the stair assembly may comprise a plurality of steps each having a forward portion and a rearward portion, the main stringer is pivotably connected to each of the plurality of steps at one of the forward portion and the rearward portion and the support stringer is pivotably connected to each of the plurality of steps at the other one of the forward portion and the rearward portion such that the steps move in unison when the support stringer is moved relative to the main stringer, (d) the camslot plate may include a first end and a second end, and the first end of the camslot plate or the second end of the camslot plate includes a pivot hole and the other of the first end of the camslot plate or the second end of the camslot plate includes an elongated slot, (e) the stair assembly may comprise a first pivot assembly configured to connect the main stringer to the camslot plate and a second pivot assembly configured to connect the support stringer to the camslot plate, (f) the first pivot assembly may be configured to pivotably connect the main stringer to the camslot plate at one of the pivot hole and the elongated slot, and the second pivot assembly may be configured to pivotably and slidably connect the support stringer to the camslot plate at the other one of the pivot hole and the elongated slot, (g) the stair assembly may comprise a removable pin, the camslot plate may comprise a plurality of camslot plate holes, the support stringer may comprise at least one support stringer hole, and the support stringer may be configured to be positioned relative to the camslot plate such that the at least one support stringer hole aligns with one of the plurality of camslot plate holes to allow the removable pin to pass therethrough and secure the support stringer relative to the camslot plate, (h) the stair assembly may comprise: a plurality of steps; two main stringers, each being connected to a corresponding lateral end of each of the plurality of steps; two support stringers, each being connected to a corresponding lateral end of each of the plurality of steps; and two camslot plates, each being connected to corresponding ones of the two main stringers and the two support stringers, (i) the stair assembly may comprise a foot that is rotatably connected to a bottom end of the main stringer to engage a ground surface during use, (j) the foot may be height adjustable relative to the bottom end, and/or (k) the stair assembly may comprise a handrail connected to the main stringer.

Another aspect of the present technology is directed to a stair assembly comprising: a plurality of steps; a main stringer pivotably connected to a corresponding lateral end of each of the plurality of steps; and a support stringer pivotably connected to a corresponding lateral end of each of the plurality of steps, wherein the main stringer and the support stringer are movably connected to the plurality of steps such that a rise and a run of each of the plurality of steps is substantially consistent when the main stringer and the support stringer are moved relative to each other to adjust the plurality of steps to a substantially level position.

In examples of any of the aspects of the preceding paragraphs of this section, (a) the stair assembly may comprise a latching mechanism joined to a top end of the main stringer, the latching mechanism being configured to releasably connect the stair assembly to an anchor or a wall mount, (b) the latching mechanism may comprise a rotary latch such that the stair assembly is rotatable relative to the anchor or the wall mount when connected thereto, (c) the stair assembly may comprise a foot that is rotatably connected to a bottom end of the main stringer to engage a ground surface during use, (d) the foot may be height adjustable relative to the bottom end, (e) the stair assembly may comprise a handrail connected to the main stringer, (f) the main stringer and the support stringer may be configured to be releasably fixed relative to each other, and/or (g) the stair assembly may comprise a camslot plate configured to guide relative movement of the main stringer and the support stringer.

Of course, portions of the aspects may form sub-aspects of the present technology. Also, various ones of the sub-aspects and/or aspects may be combined in various manners and also constitute additional aspects or sub-aspects of the present technology.

### BRIEF DESCRIPTION OF THE DRAWINGS

FIG. 1A is an exploded perspective view of a stair assembly according to an example of the present technology.

FIG. 1B is a perspective view of the stair assembly of FIG. 1A in a collapsed position.

FIG. 1C is an isolated view of an example of wall mounts that may be used in combination with the stair assembly of FIG. 1A.

FIG. 2A is an exploded perspective view of a stair assembly according to another example of the present technology.

FIG. 2B is a perspective view of the stair assembly of FIG. 2A in a collapsed position.

FIG. 2C is an isolated view of an example of wall mounts that may be used in combination with the stair assembly of FIG. 2A.

FIG. 3 is a perspective view of a stair assembly attached to a surface in an operational position according to an example of the present technology.

FIG. 4 is a side view of a stair assembly attached to a surface in an operational position according to an example of the present technology.

FIG. 5 is a side view of a stair assembly attached to a surface in another operational position according to an example of the present technology.

FIG. 6 is a side view of a stair assembly attached to a surface in another operational position according to an example of the present technology.

FIG. 7a is an exploded perspective view of a portion of steps, stringers, and a camslot plate of the stair assembly of FIG. 3.

FIG. 7b is a side view of the stair assembly of FIG. 3 in a collapsed position.

FIG. 8 is a top perspective view of the stair assembly of FIG. 3 in a collapsed position.

FIG. 9 is an isolated view of a latch mechanism and anchor of the stair assembly of FIG. 3.

FIG. 10 is a detailed perspective view of the latch mechanism of the stair assembly of FIG. 3.

FIG. 11 is an internal perspective view of the latch mechanism of FIG. 10.

FIG. 12 is a rear perspective view of the latch mechanism of FIG. 10.

FIG. 13 is an internal perspective rear view of the latch mechanism of FIG. 10.

FIG. 14 is a detailed perspective view of a pivotably mounted step of the stair assembly of FIG. 3.

FIG. 15 is an internal perspective view of FIG. 14.

FIG. 16 is an internal perspective bottom view of the step of FIG. 14.

FIG. 17 is a cross-sectional view of the step of FIG. 14.

FIG. 18 is a cross-sectional view of the step of FIG. 14 according to another example of the present technology.

FIG. 19 is a perspective view of a stair assembly according to an example of the present technology attached to an elevated surface of a vehicle, e.g., in an operational position.

FIG. 20 is an elevation view of a stair assembly according to an example of the present technology attached to a wall of a vehicle, e.g., in a storage position.

FIG. 21 is a rear perspective view of a latch mechanism with a stopper according to another example of the present technology.

FIG. 22 is an internal perspective rear view of a latch mechanism with a stopper according to another example of the present technology.

FIG. 23 is a perspective view of the stopper of FIGS. 21-22.

FIG. 24 is a side view of a stair assembly attached to a surface in an operational position according to another example of the present technology.

FIG. 25 is a side view of a stair assembly attached to a surface in an operational position according to another example of the present technology.

### DETAILED DESCRIPTION OF THE TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further example.

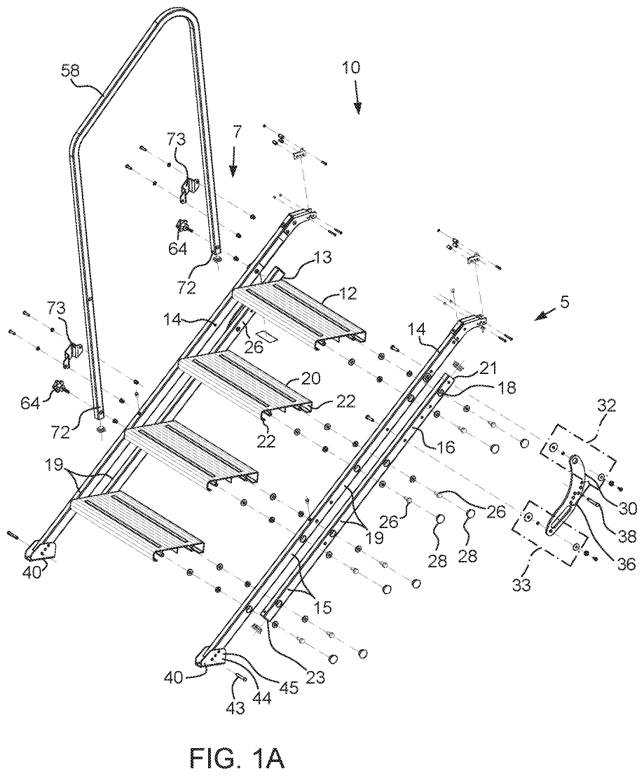

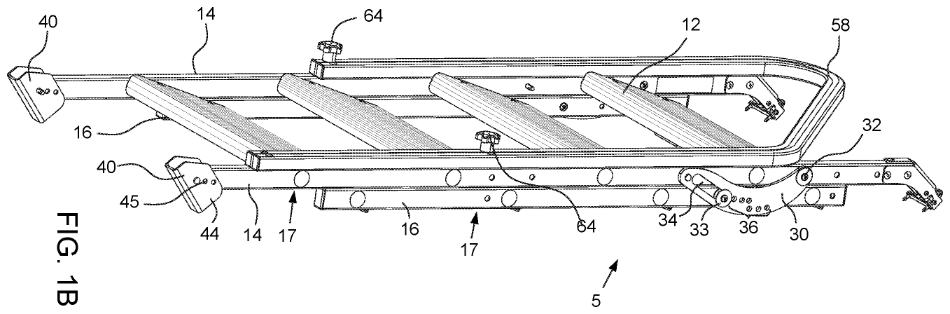

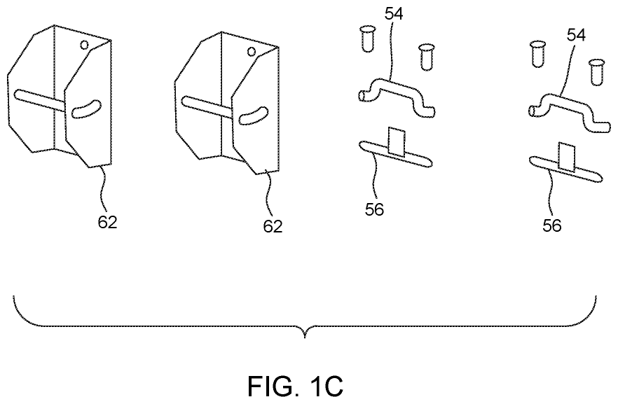

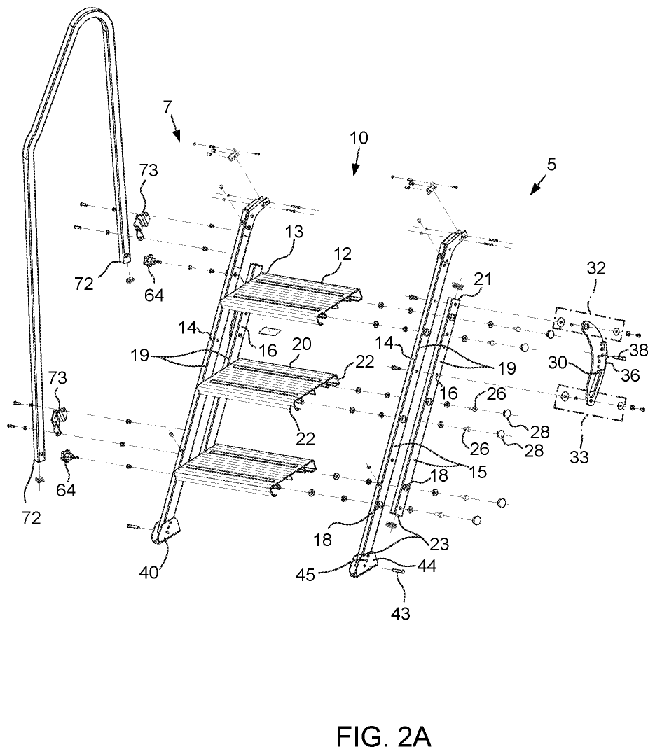

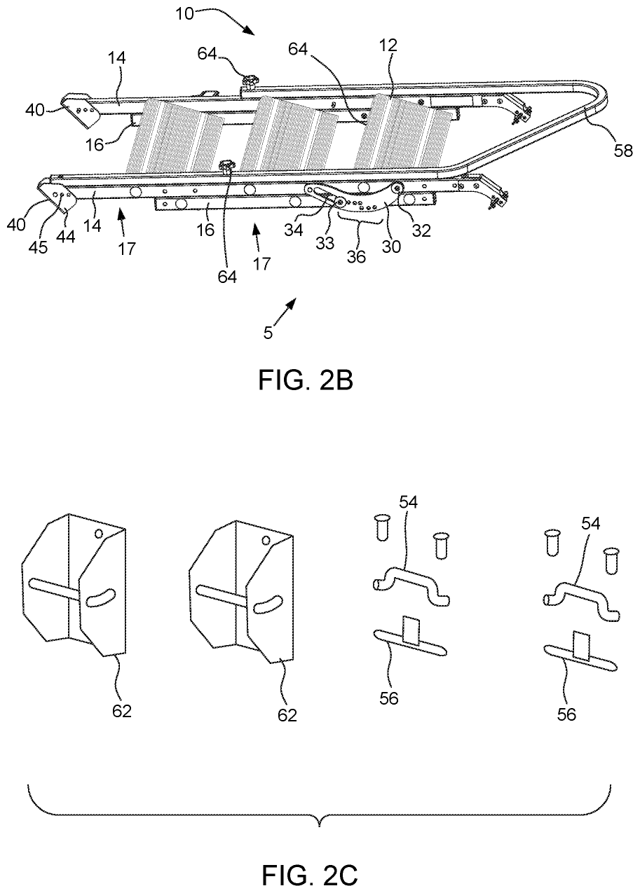

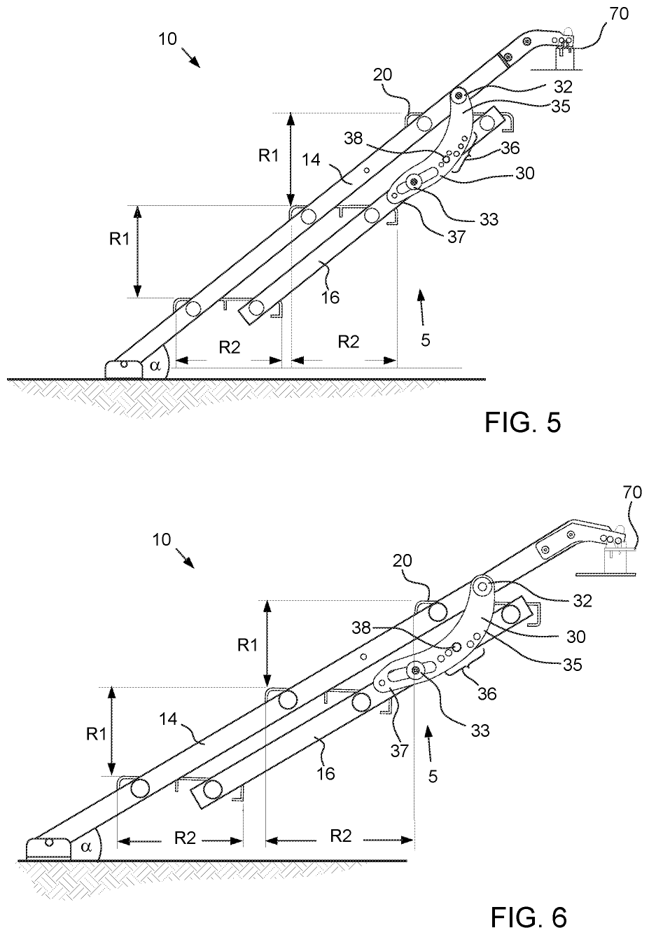

FIGS. 1-6 show examples of a stair assembly 10 according to examples of the present technology. The stair assembly 10 includes a plurality of steps 12, each of which may be secured and suspended at each lateral end 13 by a main stringer or rail 14 that runs the entire length of the stair assembly 10, e.g., from ground to threshold, and a support stringer or rail 16 that may be substantially shorter than the main stringer or rail 14. In the depicted examples, the main stringer 14 and the support stringer 16 may each be constructed from a hollow tube having a square or rectangular cross-section with a front wall 15, a rear wall 17, two side walls 19, an open top end 21, and an open bottom end 23. In other examples, the main stringer 14 and the support stringer 16 may be constructed from tubes having a circular or oval-shaped cross-section. The main stringer 14 and the support stringer 16 may each have apertures 18 through their respective two side walls 19 that correspond to each step 12. The tubes may be constructed, e.g., extruded, from an aluminum alloy or steel or may be constructed from a composite material.

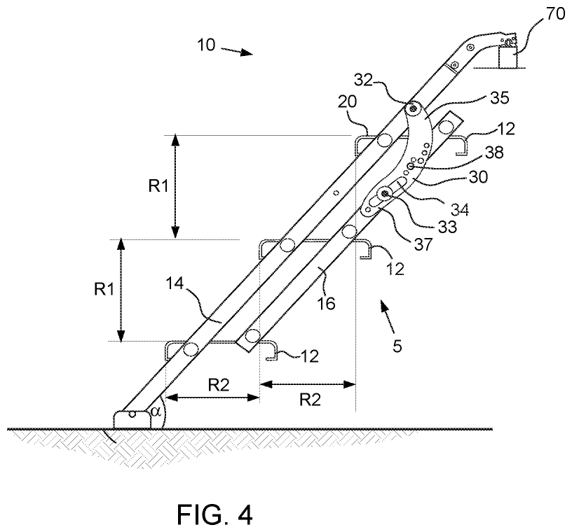

FIGS. 4-6 also show the stair assembly 10 at different angles a relative to the ground, e.g., due to being mounted to a threshhold at different heights from the ground. These views show that the stair assembly 10 provides a level or nearly level orientation of the planar stepping surface 20 for the user to walk on, as well as how the rise R1 and the run R2 of the steps 12 remains consistent at any given height/angle of adjustment.

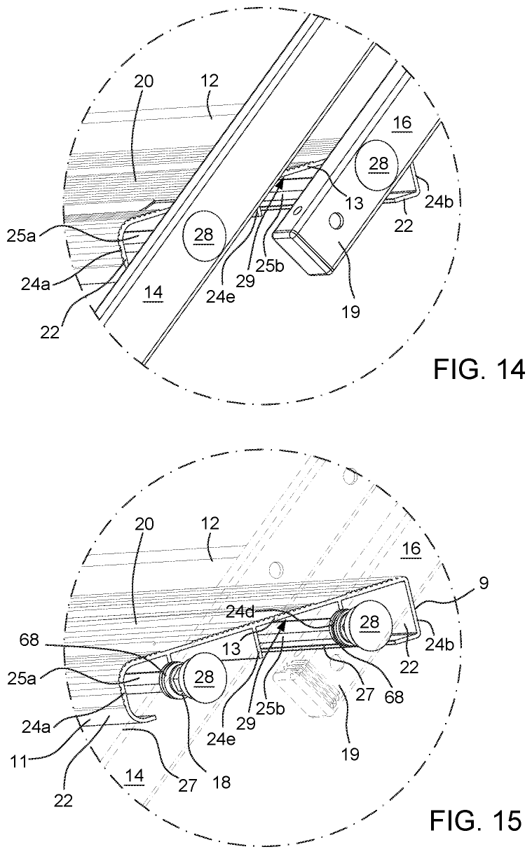

FIGS. 14-15 show that each step 12 may include a planar stepping surface 20, which a user's foot may contact during use for example, and five stiffeners 24a-e. The planar stepping surface 20 and stiffeners 24a-e may extend between the lateral ends 13 of each step 12. It is also envisioned that each step 12 may include fewer or greater than the five stiffeners 24a-e shown. The stiffeners 24a-e may extend from a surface 29 of the step 12 that is opposite the planar stepping surface 20. A return 27 may extend from a first stiffener 24a nearest a front end 11 of the step 12, and a similar return 27 may extends from a second stiffener 24b nearest the back end 9 of the step 12. The first stiffener 24a and the second stiffener 24b and respective returns 27 may cooperate to define respective U-shaped regions 22. A third stiffener 24c may be positioned adjacent the first stiffener 24a and may include a first screw boss 25a at the lateral end 13. A fourth stiffener 24d may be positioned adjacent the second stiffener 24b, and similarly may include a second screw boss 25b at the lateral end 13. A fifth stiffener 24e may extend from the surface 29 of the step 12 that is opposite the planar stepping surface 20, e.g., at the midpoint of the surface 29 between the front end 11 and the back end 9. As noted above, in other examples, there may be fewer or more than five stiffeners 24, and it may be possible to include no stiffeners, if the step 12 is sufficiently rigid otherwise, but screw bosses 25a, 25b may still be included for joining steps 12 to the main stringer 14 and the support stinger 16, as will be described below. In further examples, the screw bosses 25a, 25b may be omitted from the step 12 or may be separate from but attached to the step 12. The steps may be constructed, e.g., extruded, from an aluminum alloy or steel or may be constructed from a composite material. Alternatively, the step 12 may be constructed from sheetmetal, such as steel, and may also include treads, such as diamond plate.

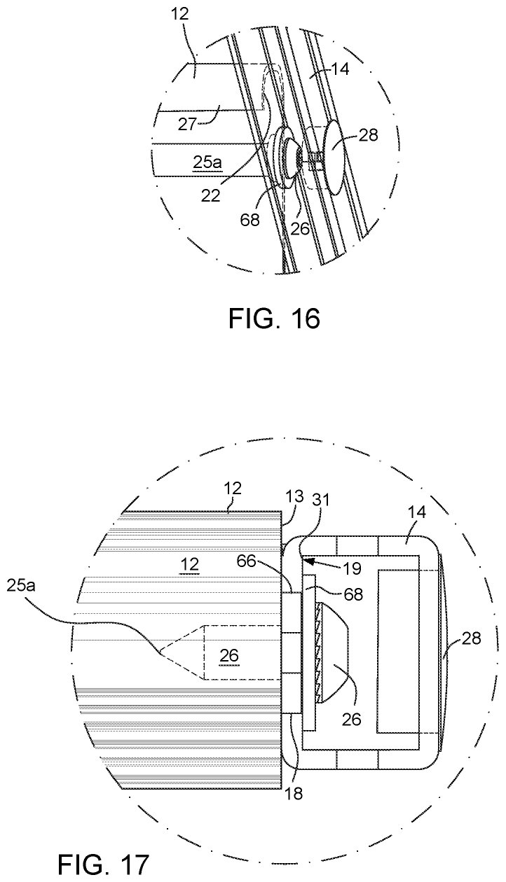

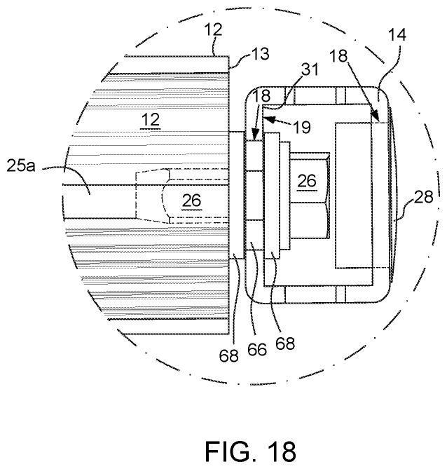

A forward portion of each step 12 may be pivotably mounted to the main stringer 14, and a rearward portion of each step 12 may be pivotably mounted to the support stringer 16. More specifically, the main stringer 14 may be pivotably connected to the first screw boss 25a, and the support stringer 16 may be pivotably connected to the second screw boss 25b. The main stringer 14 and the support stringer 16 may be secured to the screw bosses 25a, 25b by fasteners 26 extending through corresponding apertures 18 formed on the side walls 19 of each of the main stringer 14 and the support stringer 16, and a washer 68 may be provided between the fastener 26 and an interior surface 31 of a corresponding side wall 19 of each main stringer 14 and support stringer 16, as shown in FIGS. 16-18. As shown in FIG. 18, a spacer 66 may be disposed in the aperture 18 between fastener elements 26 to facilitate the free rotation between the step 12 and the main stringer 14 and the support stringer 16, e.g., by spacing the step 12 from the main stringer 14 and the support stringer 16. The spacer 66 may be thicker than the side wall 19 of the main stringer 14 or the support stringer 16 in which it is installed to inhibit engagement of the washers 68 with the side wall 19. A cap 28 may be fitted to cover the aperture 18 of the outer side wall 19 of each of the main stringer 14 and the support stringer 16 for aesthetic purposes and for protection of the fasteners 26 and the interior of the main stringer 14 and the support stringer 16 from contamination.

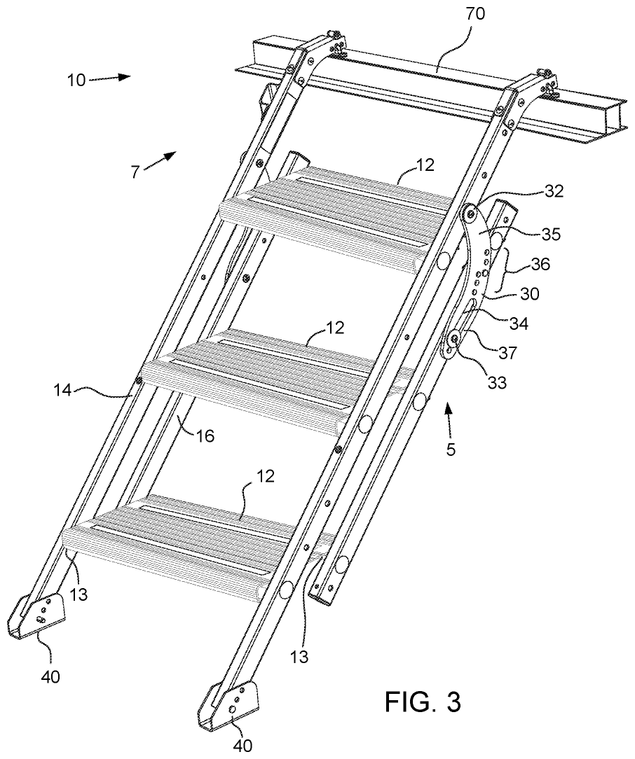

FIGS. 3-6 show a first connecting member or camslot plate 30 that may pivotably connect the main stringer 14 and the support stringer 16 at a first side 5 of the stair assembly 10, and a second connecting member or camslot plate 30 may pivotably connect the main stringer 14 and the support stringer 16 at a second side 7 of the stair assembly 10. The first camslot plate 30 may be pivotably connected proximate a first end 35 thereof to the main stringer 14 by a first pivot assembly 32. The first camslot plate 30 may be pivotably and slidingly connected proximate a second end 37 thereof to the support stringer 16 by a second pivot assembly 33. The first pivot assembly 32 and the second pivot assembly 33 may each include one or more fastening components, such as a nut or an internally threaded pin, a bolt, one or more washers, and a spacer or a bearing. The two sides 5, 7 of the stair assembly 10 may be mirror images of each other, and therefore only one side will be described. Thus, one camslot plate 30, as well as the associated components and features thereof, may be provided on each side 5, 7 of the stair assembly 10.

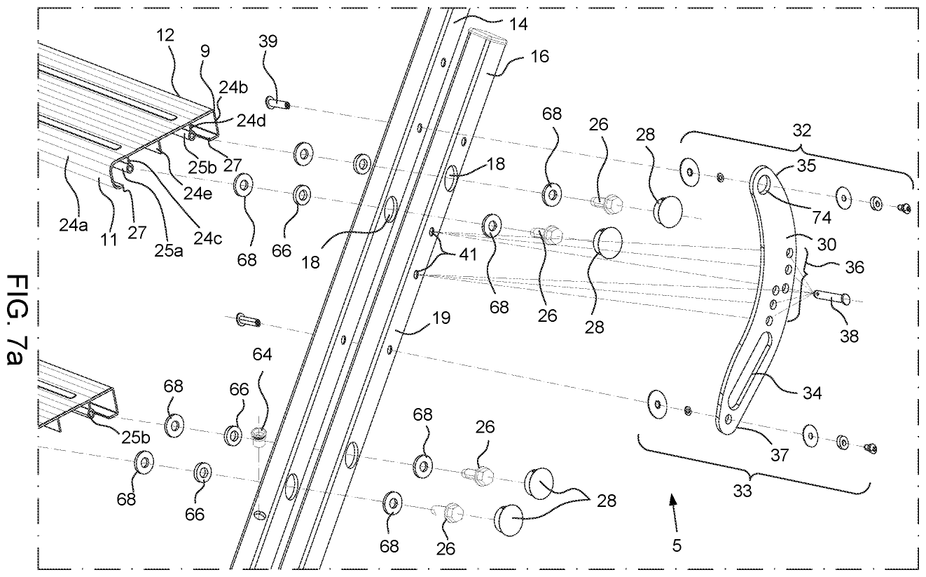

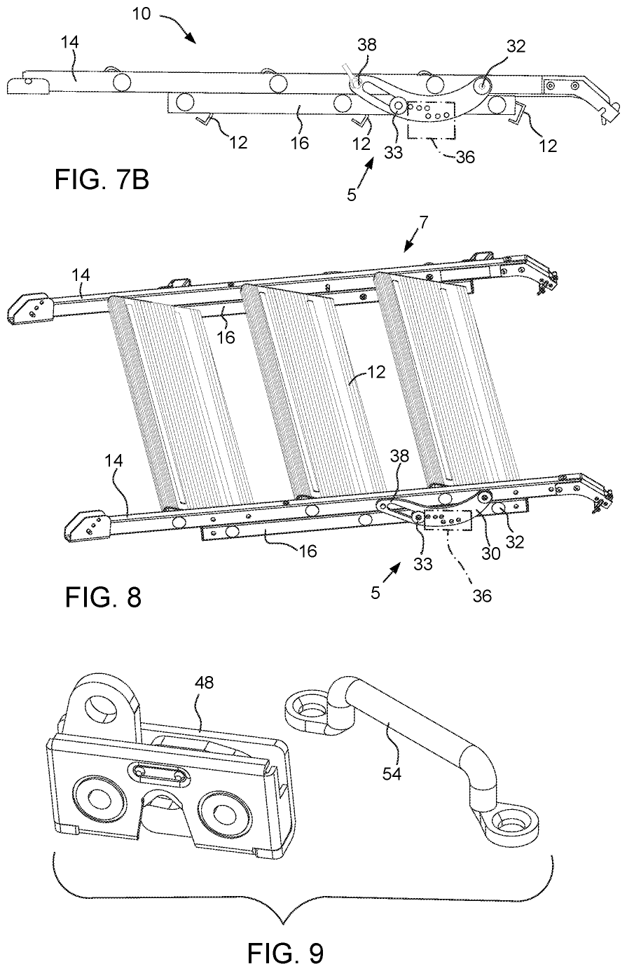

As shown in FIG. 7a, the first pivot assembly 32 and the second pivot assembly 33 may be joined to plate retaining members or pegs 39 mounted on the side walls 19 of the main stringer 14 and the support stringer 16. Alternatively, the pegs 39 may be disposed on another face of the main stringer 14 and the support stringer 16. The first end 35 of the camslot plate 30 may be secured by the first pivot assembly 32 of the main stringer 14 located proximate the uppermost end 21 of the stair assembly 10. In other examples, the camslot plate 30 may be disposed elsewhere along the main stringer 14 and the support stringer 16. The first end 35 of the camslot plate 30 may include a hole 74 that pivotably engages the first pivot assembly 32 connected to the main stringer 14. The second end 37 of the camslot plate 30 may include an elongated slot 34 that pivotably and slidably engages the second pivot assembly 33 connected to the support stringer 16.

The first end 35 of the camslot plate 30 may pivot about the first pivot assembly 32, which connects the camslot plate 30 to the main stringer 14, and the second end 37 of the camslot plate 30 may pivot about and slide relative to the second pivot assembly 33, which connects the camslot plate 30 to the support stringer 16. The camslot plate 30 may cooperate with the first pivot assembly 32 and the second pivot assembly 33 to restrict the extent to which the step 12 may pivot with respect to the main stringer 14 and the support stringer 16.

The camslot plate 30 may include a plurality of camslot plate holes or apertures 36 disposed between the first end 35 of the camslot plate 30 and the elongated slot 34. When the stair assembly 10 is assembled, one of the plurality of camslot plate holes 36 may be aligned with a corresponding hole 41 in the support stringer 16 that penetrates the side walls 19 of the support stringer 16 and may be secured in place by a removable pin 38, or a similar locking mechanism, to hold the main stringer 14, the support stringer 16, and the steps 12 in a desired configuration with respect to each other. As best seen in FIG. 7a, the pin 38 may be inserted into one of six camslot plate holes 36 in the camslot plate 30 that may align with one of two holes 41 in the outer side wall 19 of the support stringer 16 to secure the stair assembly 10 in one of multiple angles. The number of camslot plate holes 36 on the camslot plate 30 and the number of holes 41 on the support stringer 16 may be varied depending on the desired number of different positions for the stair assembly 10 (e.g., as shown in FIGS. 4-6). In a further example, the first end 35 of the camslot plate 30 may include the elongated slot 34 and be slidably mounted to the support stringer 16 and the second end 37 of the plate may be pivotably mounted to the main stringer 14. In a still further example, the first end 35 of the camslot plate 30 may include the elongated slot 34 and may be slidably mounted to the main stringer 14 and the second end 37 of the camslot plate 30 may be pivotably mounted to the support stringer 16. In a still further example, the elongated slot 34 may be formed on one of the main stringer 14 and the support stringer 16 and the pivot hole 74 may be formed on the other one of the main stringer 14 and the support stringer 16 and the first pivot assembly 32 and the second pivot assembly 33 are positioned on the connecting member 30 to engage the elongated slot 34 and the pivot hole 74, respectively.

The ends 23 of the main stringers 14 that engage the ground may include a foot 40 secured by a pin or bolted shaft 43 so that the foot 40 engages the ground when the stair assembly 10 is installed on a threshold. The foot 40 may pivot about the pin 43 with respect to the main stringer 14 so that the foot 40 is moveable to sit flush with the ground at any angle a of the stair assembly 10. In some examples, the foot 40 may have side surfaces 44 with multiple holes 45 along the height of each side surface 44 for selective vertical adjustment of the foot 40 relative to the main stringer 14 to accommodate significantly uneven ground underneath the stair assembly 10.

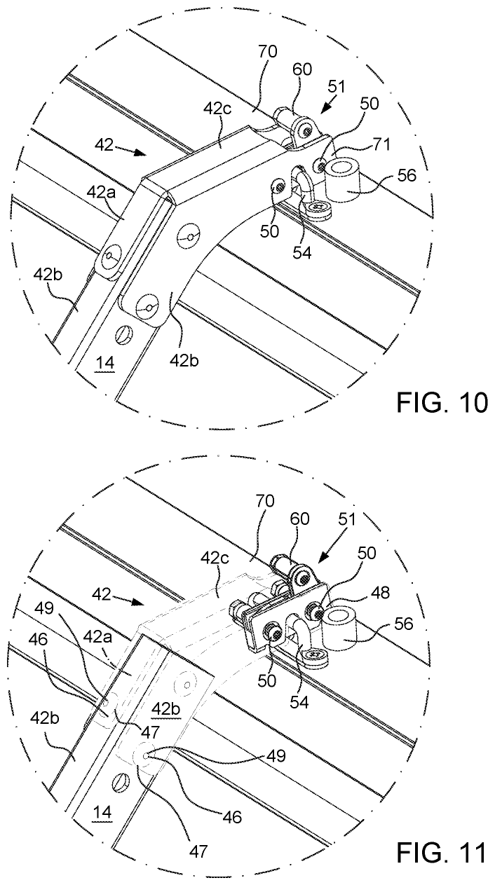

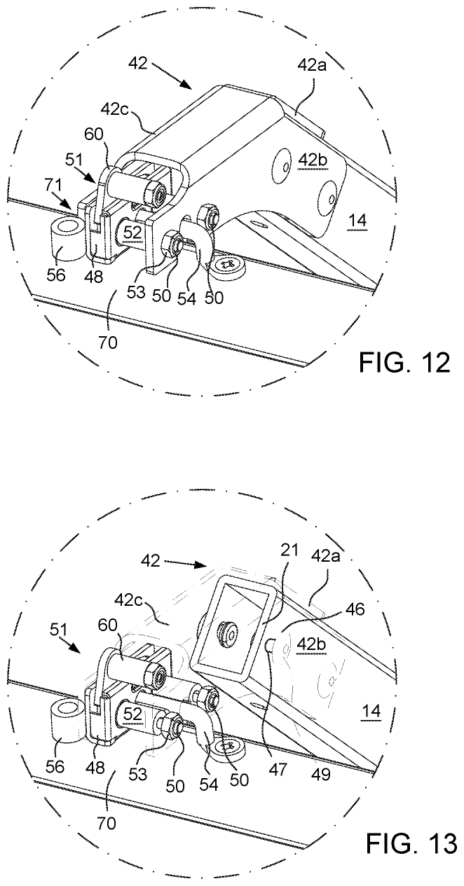

The uppermost ends 21 of the main stringers 14 may be connected to an extender piece 42 that may be bent at an angle from the main stringer 14 and that may house a latching mechanism 51, as shown in FIGS. 10-13. As both sides of the stair assembly 10 are mirror images of each other, only one side will be described. The extender piece 42 may include an angled top flange 42a and side flanges 42b with mounting holes 46 that correspond with apertures 47 in the side walls 19 and the front wall 15 of the main stringer 14. Fasteners 49 may be used to join the extender piece 42 to the main stringer 14 at the mounting holes 46 and apertures 47. The extender piece 42 may include a latch housing 42c that is continuous with the top flange 42a and the side flanges 42b and is bent at an obtuse angle relative to the top flange 42a such that when the stair assembly 10 is installed in an operational position mounted to the patio of an RV the stair assembly 10 will extend downward from the patio to the ground. A rotary latch 48, such as an R4 rotary latch from SOUTHCO®, as shown in FIG. 9, may be mounted inside of the latch housing 42c against one of the side flanges 42b. The latch 48 may be held in place by two bolts 50 that penetrate the rotary latch 48 and both side flanges 42b of the latch housing 42c. Spacers 52 may be placed on the bolts 50 for tight fitting of the latch 48 between the side flanges 42b of the latch housing 42c. Fasteners, such as nuts 53, may be installed onto the bolts 50 to be flush with and tightly abut the outside of the side flange 42b of the latch housing 42c, which precludes rotation of either the bolt 50 or the spacer 52.

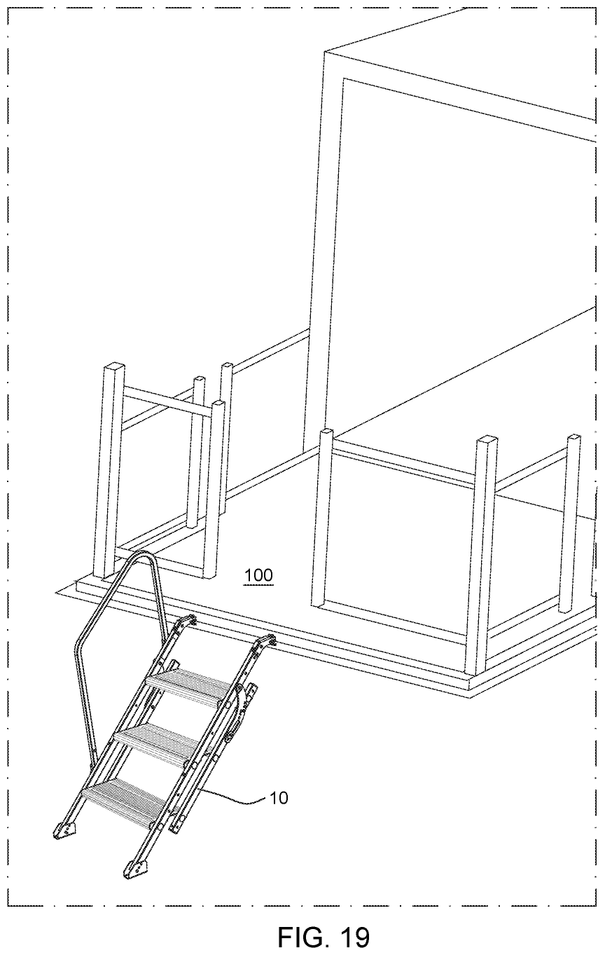

An anchor or strike 54 may be mounted onto the threshold 70, which may lead to a patio, an elevated surface, an upstairs area, or the entryway to the living space. There may also be a stopper 56 mounted onto the threshold 70, which may be made of any suitable material such as rubber, plastic, or metal. The anchor 54 and the stopper 56 may be spaced to accommodate the size of the latching mechanism 51 when the stair assembly 10 is in the latched position on the threshold 70. The stair assembly 10 may be installed by positioning the extender pieces 42 of the top end 21 of the stair assembly 10 over the anchors 54 installed on the threshold 70 and forcing the extender pieces 42 downward so that the latches 48 catch and lock onto the anchors 54. In this position, a free end 71 of the extender piece 42 may abut the stopper 56 to mitigate vibration and movement in the top end 21 of the stair assembly 10. The anchor 54 may be sized and positioned on the threshold 70 so that both the extender piece 42 and the top end 21 of the main stringer 14 are spaced from and do not contact the threshold 70 when the stair assembly 10 is in the latched position. The bottom end 23 of the stair assembly 10 that includes the feet 40 may then be placed on the ground to be level with the ground at the appropriate distance from the living space, e.g., a patio or elevated surface 100, as shown in FIG. 19. The steps 12 may then be adjusted to a level position between the main stringer 14 and the support stringer 16 and then locked into place by insertion of the pins 38 into one of the plurality of camslot plate holes 36 of the camslot plates 30 and a corresponding hole 41 in the support stringer 16. The stair assembly 10 may also include one or more handrails 58 containing apertures 72 that may correspond to apertures in the outer side wall 19 of the main stringer 14 and/or the support stringer 16 for insertion of a threaded knob 64. Handrail guides 73 may also be attached to the main stringer 14 to form a channel around the handrail 58 to prevent rotation of the handrail 58 relative to the main stringer 14, guide proper installation of the handrail 58, and to improve handrail 58 stability.

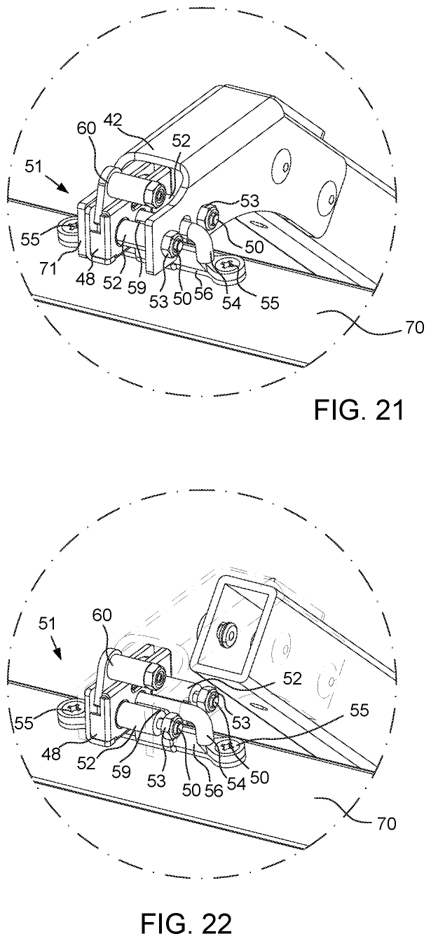

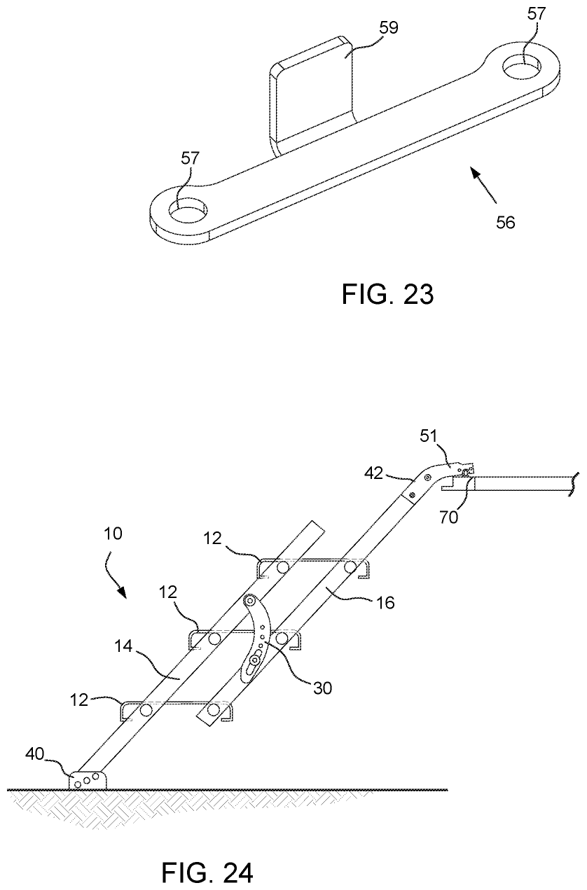

FIGS. 21-23 show further examples of a stopper 56 according to another example of the present technology. The stopper 56 according to this example includes mounting holes 57 through which bolts 55 may pass, along with the anchor 54, to attach the stopper 56 and the anchor 54 to a surface of the threshold 70. The stopper 56 also includes a stopper tab 59 that extends into the extender piece 42 and between the spacer 52 and the anchor 54. The stopper tab 59 may contact the inside of the extender piece 42 to constrain lateral motion of the stair assembly 10 when it is engaged with the anchors 54 on the threshold 70.

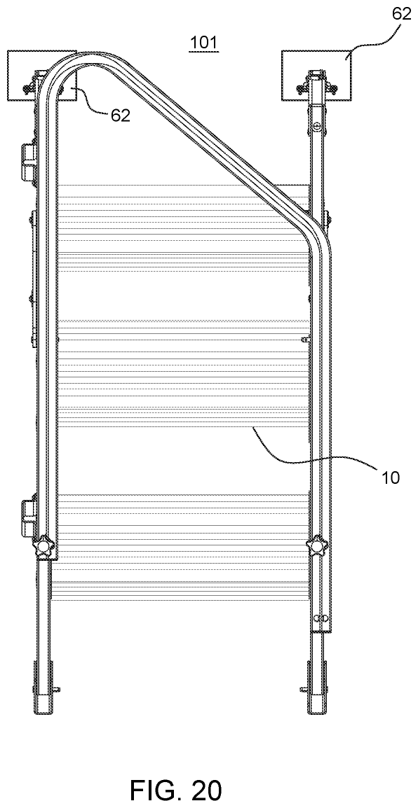

The stair assembly 10 may be placed into a collapsed position, as shown in FIGS. 7b and 8, by adjusting the main stringer 14 and the support stringer 16 via the camslot plates 30 to be flush or nearly flush with each other and locking the position with the pins 38. Referencing FIGS. 10-13, the latching mechanisms 51 may be released by actuating the lever 60 connected to the rotary latch 48. The handrail 58 may be laid flat against the main stringers 14 of both sides of the stair assembly 10 and secured together by fasteners such as threaded knobs 64 inserted into corresponding holes in both the handrail 58 and front wall 15 of at least one of the main stringers 14, as shown in FIGS. 1B, 2B, and 7a. The stair assembly 10 may then be stowed against a wall 101, such as inside of a towable trailer, for example as shown in FIG. 20, by connecting it to hooks or wall mounts 62 installed to the wall surface where storage is desired.

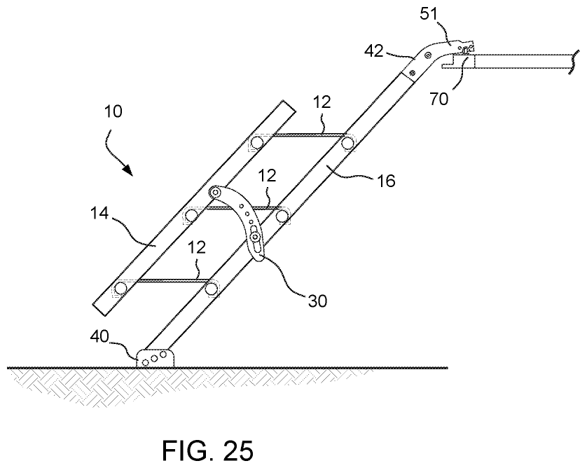

FIGS. 24 and 25 depict further examples of the stair assembly 10. In FIG. 24, the main stringer or primary stringer or forward stringer 14 is attached to a forward portion of each of the steps 12 and the support stringer or secondary stringer or rearward stringer 16 is attached to a rearward portion of each of the steps 12. A foot 40 is attached to lower end of the forward stringer 14 to contact the ground and the extender piece 42 and latching mechanism 51 are attached to the upper end of the rearward stringer 16 to attach the stair assembly 10 to the threshold 70. Also, a camslot plate 30 is provided to permit releasable adjustment between positions, similar to the examples described above. FIG. 25 shows another example, in which the support stringer 16 includes the foot 40, the extender piece 42, and the latching mechanism 51. In this example, the main stringer 14 is movably connected to the support stringer 16 via the camslot plate 30, similar to the examples described above.

It is to be understood that the technology is not to be limited to the disclosed examples, but on the contrary, is intended to cover various modifications and equivalent arrangements included within the spirit and scope of the appended claims.

REFERENCE CHARACTER LISTING

| | |
|---|---|
| first side | 5 |
| second side | 7 |
| back end | 9 |
| stair assembly | 10 |
| front end | 11 |
| step | 12 |
| lateral end | 13 |
| main stringer | 14 |
| front wall | 15 |
| support stringer | 16 |
| rear wall | 17 |
| aperture | 18 |
| side wall | 19 |
| planar stepping surface | 20 |
| open top end | 21 |
| U - shaped region | 22 |
| open bottom end | 23 |
| first stiffener | 24a |
| second stiffener | 24b |
| third stiffener | 24c |
| fourth stiffener | 24d |
| fifth stiffener | 24e |
| first screw boss | 25a |
| second screw boss | 25b |
| fastener | 26 |
| insert | 27 |
| cap | 28 |
| surface | 29 |
| camslot plate | 30 |
| interior surface | 31 |
| first pivot assembly | 32 |
| second pivot assembly | 33 |
| slot | 34 |
| first end | 35 |
| camslot plate holes | 36 |
| second end | 37 |
| pin | 38 |
| peg | 39 |
| foot | 40 |
| hole | 41 |
| extender piece | 42 |
| top flange | 42a |
| side flange | 42b |
| latch housing | 42c |
| pin | 43 |
| side surface | 44 |
| hole | 45 |
| mounting hole | 46 |
| aperture | 47 |
| rotary latch | 48 |
| fastener | 49 |
| bolt | 50 |
| latching mechanism | 51 |
| spacer | 52 |
| nut | 53 |
| anchor | 54 |
| bolt | 55 |
| stopper | 56 |
| mounting hole | 57 |
| handrail | 58 |
| stopper tab | 59 |
| lever | 60 |
| wall mounts | 62 |
| knobs | 64 |
| spacer | 66 |
| washers | 68 |
| threshold | 70 |
| free end | 71 |
| aperture | 72 |
| locking plate | 73 |
| pivot hole | 74 |
| elevated surface | 100 |
| wall | 101 |
| rise | R1 |
| run | R2 |
| angle | α |

1. A stair assembly comprising:
at least one step;
a main stringer pivotably connected to the at least one step;
a support stringer pivotably connected to the at least one step; and
a camslot plate pivotably connected to one of the main stringer and the support stringer and pivotably and slidably connected to the other of the main stringer and the support stringer.

2. The stair assembly of claim 1, further comprising a latching mechanism joined to a top end of the main stringer, the latching mechanism being configured to releasably connect the stair assembly to an anchor or a wall mount.

3. The stair assembly of claim 2, wherein the latching mechanism further comprises a rotary latch such that the stair assembly is rotatable relative to the anchor or the wall mount when connected thereto.

4. The stair assembly of claim 1, further comprising a plurality of steps, each of the steps having a forward portion and a rearward portion,
wherein the main stringer is pivotably connected to each of the plurality of steps at one of the forward portion and the rearward portion and the support stringer is pivotably connected to each of the plurality of steps at the other one of the forward portion and the rearward portion such that the steps move in unison when the support stringer is moved relative to the main stringer.

5. The stair assembly of claim 1, wherein the camslot plate includes a first end and a second end, and
wherein the first end of the camslot plate or the second end of the camslot plate includes a pivot hole and the other of the first end of the camslot plate or the second end of the camslot plate includes an elongated slot.

6. The stair assembly of claim 5, further comprising a first pivot assembly configured to connect the main stringer to the camslot plate and a second pivot assembly configured to connect the support stringer to the camslot plate.

7. The stair assembly of claim 6, wherein the first pivot assembly is configured to pivotably connect the main stringer to the camslot plate at one of the pivot hole and the elongated slot, and
wherein the second pivot assembly is configured to pivotably and slidably connect the support stringer to the camslot plate at the other one of the pivot hole and the elongated slot.

8. The stair assembly of claim 1, further comprising a removable pin,
wherein the camslot plate further comprises a plurality of camslot plate holes,
wherein the support stringer further comprises at least one support stringer hole, and
wherein the support stringer is configured to be positioned relative to the camslot plate such that the at least one support stringer hole aligns with one of the plurality of camslot plate holes to allow the removable pin to pass therethrough and secure the support stringer relative to the camslot plate.

9. The stair assembly of claim 1, further comprising:
a plurality of steps;
two main stringers, each being connected to a corresponding lateral end of each of the plurality of steps;
two support stringers, each being connected to a corresponding lateral end of each of the plurality of steps; and
two camslot plates, each being connected to corresponding ones of the two main stringers and the two support stringers.

10. The stair assembly of claim 1, further comprising a foot that is rotatably connected to a bottom end of the main stringer to engage a ground surface during use.

11. The stair assembly of claim 10, wherein the foot is height adjustable relative to the bottom end.

12. The stair assembly of claim 1, further comprising a handrail connected to the main stringer.

13. A stair assembly comprising:
a plurality of steps;
a main stringer pivotably connected to a corresponding lateral end of each of the plurality of steps; and
a support stringer pivotably connected to a corresponding lateral end of each of the plurality of steps,
wherein the main stringer and the support stringer are movably connected to the plurality of steps such that a rise and a run of each of the plurality of steps is substantially consistent when the main stringer and the support stringer are moved relative to each other to adjust the plurality of steps to a substantially level position.

14. The stair assembly of claim 13, further comprising a latching mechanism joined to a top end of the main stringer, the latching mechanism being configured to releasably connect the stair assembly to an anchor or a wall mount.

15. The stair assembly of claim 14, wherein the latching mechanism further comprises a rotary latch such that the stair assembly is rotatable relative to the anchor or the wall mount when connected thereto.

16. The stair assembly of claim 13, further comprising a foot that is rotatably connected to a bottom end of the main stringer to engage a ground surface during use.

17. The stair assembly of claim 16, wherein the foot is height adjustable relative to the bottom end.

18. The stair assembly of claim 13, further comprising a handrail connected to the main stringer.

19. The stair assembly of claim 13, wherein the main stringer and the support stringer are configured to be releasably fixed relative to each other.

20. The stair assembly of claim 13, further comprising a camslot plate configured to guide relative movement of the main stringer and the support stringer.
